(19) United States
(12) Patent Application Publication
(10) Pub. No.: US 2026/0164408 A1
(43) Pub. Date: Jun. 11, 2026

(54) APPARATUS AND METHOD FOR SUPPORTING RESOURCE SELECTION FOR COMMUNICATION BETWEEN TERMINALS BY USING COOPERATION MESSAGE BETWEEN TERMINALS IN WIRELESS COMMUNICATION SYSTEM

(71) Applicant: Samsung Electronics Co., Ltd., Suwon-si, Gyeonggi-do (KR)

(72) Inventors: Jeongseok YU, Suwon-si (KR); Anil AGIWAL, Suwon-si (KR); Hyunjeong KANG, Suwon-si (KR)

(21) Appl. No.: 18/722,295

(22) PCT Filed: Dec. 20, 2022
(86) PCT No.: PCT/KR2022/020859

§ 371 Date: Jun. 20, 2024

(30) Foreign Application Priority Data
Dec. 21, 2021 (KR) 10-2021-0183476
Jan. 11, 2022 (KR) 10-2022-0003956

(51) Int. Cl. H04W 72/02; H04W 72/25; H04W 72/543; H04W 92/18

(52) U.S. Cl. CPC H04W 72/02; H04W 72/25; H04W 72/543; H04W 92/18

(57) ABSTRACT

The present disclosure relates to a 5G or 6G communication system for supporting a higher data transmission rate. According to various embodiments of the present disclosure, it is possible to provide an apparatus and method for supporting resource selection for communication between terminals by using a cooperation message between terminals in a next generation wireless communication system.

### TECHNICAL FIELD

The disclosure relates to an apparatus and a method for supporting resource selection for communication between terminals by using a cooperation message between terminals in a next-generation wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave such as 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

In the initial stage of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology(for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, NR-U(New Radio Unlicensed) aimed at system operations conforming to various regulation-related requirements in unlicensed bands, NR UE Power Saving, Non-Terrestrial Network(NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI(Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The disclosure proposes a method of differentiating inter-UE coordination information, which may be used for resource selection or reselection for sidelink communication in a next-generation wireless communication system, into service priority and destination/non-destination terminals.

The technical subjects pursued in the disclosure may not be limited to the above-mentioned technical subjects, and other technical subjects which are not mentioned may be clearly understood, through the following descriptions, by those skilled in the art to which the disclosure pertains.

### Solution to Problem

A method performed by a first terminal in a wireless communication system according to an embodiment of the disclosure to solve the above problems may include receiving, from a base station, a first message comprising configuration information of an inter-UE (user equipment) coordination scheme 2; transmitting, to a second terminal, sidelink control information (SCI) comprising resource allocation information for sidelink communication between the first terminal and the second terminal; based on the SCI, receiving, from the second terminal, a second message comprising conflict information indicating that the resource for the sidelink communication and another transmission resource configured to the second terminal conflict; and reselecting resources for sidelink communication with the second terminal, based on the conflict information.

In addition, the SCI may further include information on whether the first terminal is able to receive the conflict information from the second terminal.

In addition, the second message may be transmitted in a physical sidelink feedback channel (PSFCH).

In addition, the conflict information may be maintained for a time determined based on a remaining packet delay budget.

In addition, a method performed by a second terminal in a wireless communication system according to an embodiment of the disclosure to solve the above problems may include receiving, from a first terminal, sidelink control information (SCI) comprising resource allocation information for sidelink communication between the first terminal and the second terminal, according to configuration of an inter-UE (user equipment) coordination scheme 2; based on the SCI, determining whether the resource for the sidelink communication and another transmission resource configured to the second terminal conflict; and transmitting, to the first terminal, a message including conflict information indicating that the resource for the sidelink communication and another transmission resource configured to the second terminal conflict, in case that the resource for the sidelink communication and another transmission resource configured to the second terminal conflict.

In addition, a first terminal in a wireless communication system according to an embodiment of the disclosure to solve the above problems may include a transceiver; and a controller coupled with the transceiver and configured to receives, from a base station, a first message comprising configuration information of an inter-UE (user equipment) coordination scheme 2, transmits, to a second terminal, sidelink control information (SCI) comprising resource allocation information for sidelink communication between the first terminal and the second terminal, based on the SCI, receives, from the second terminal, a second message comprising conflict information indicating that the resource for the sidelink communication and another transmission resource configured to the second terminal conflict, and reselects resources for sidelink communication with the second terminal, based on the conflict information.

In addition, a second terminal in a wireless communication system according to an embodiment of the disclosure to solve the above problems may include a transceiver; and a controller coupled with the transceiver and configured to receives, from a first terminal, sidelink control information (SCI) comprising resource allocation information for sidelink communication between the first terminal and the second terminal, according to configuration of an inter-UE (user equipment) coordination scheme 2, based on the SCI, determines whether the resource for the sidelink communication and another transmission resource configured to the second terminal conflict, and transmits, to the first terminal, a message including conflict information indicating that the resource for the sidelink communication and another transmission resource configured to the second terminal conflict, in case that the resource for the sidelink communication and another transmission resource configured to the second terminal conflict.

### Advantageous Effects of Invention

According to various embodiments, the disclosure provides a method for flexibly coping with the requirements of services and operators under various conditions by providing differentiation in consideration of the priority of data transmitted through the configuration of the conditions for UE-A to transmit inter-UE coordination information and conditions for UE-B to use the received inter-UE coordination information in inter-UE coordination scheme 2 that may be used in sidelink resource allocation mode 2, and destination/non-destination terminals.

Effects obtainable from the disclosure may not be limited to the above-mentioned effects, and other effects which are not mentioned may be clearly understood, through the following descriptions, by those skilled in the art to which the disclosure pertains.

### BRIEF DESCRIPTION OF DRAWINGS

FIG. 1 illustrates a wireless communication system according to various embodiments of the disclosure.

FIG. 2 illustrates a configuration of a base station in a wireless communication system according to various embodiments of the disclosure.

FIG. 3 illustrates a configuration of a terminal in a wireless communication system according to various embodiments of the disclosure.

FIGS. 4A to 4C illustrate configurations of a communication unit in a wireless communication system according to various embodiments of the disclosure.

FIG. 5 illustrates a situation in which direct communication between terminals is performed using unicast, groupcast, or broadcast method according to various embodiments of the disclosure.

FIGS. 6A and 6B illustrate a direct communication procedure between terminals, which are referenced in the disclosure, using sidelink unicast, groupcast, and broadcast methods and a method for identifying whether a destination terminal is present.

FIG. 7 illustrates a method of providing UE-B with configurations for inter-UE coordination scheme 2 according to various embodiments of the disclosure.

FIG. 8 illustrates the operation of UE-B's inter-UE coordination scheme 2 according to various embodiments of the disclosure.

FIG. 9 illustrates a method of providing UE-A with configurations for inter-UE coordination scheme 2 according to various embodiments of the disclosure.

FIG. 10 illustrates the operation of UE-A's inter-UE coordination scheme 2 according to various embodiments of the disclosure.

FIG. 11 illustrates a method for transmitting an inter-UE coordination message of UE-A's inter-UE coordination scheme 2 according to various embodiments of the disclosure.

### MODE FOR THE INVENTION

Hereinafter, embodiments of the disclosure will be described in detail with reference to the accompanying drawings. It should be noted that, in the accompanying drawings, the same or like elements are designated by the same or like reference signs as much as possible. Furthermore, detailed descriptions of known functions or configurations that may make the subject matter of the disclosure unclear will be omitted.

The terms used in the disclosure are only used to describe specific embodiments, and may not be intended to limit the disclosure. In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea. A singular expression may include a plural expression unless they are definitely different in a context. Unless defined otherwise, all terms used herein, including technical and scientific terms, have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

Hereinafter, various embodiments of the disclosure will be described based on an approach of hardware. However, various embodiments of the disclosure include a technology that uses both hardware and software, and thus the various embodiments of the disclosure may not exclude the perspective of software.

Hereinafter, the disclosure relates to an apparatus and method for determining radio resources in a wireless communication system. Specifically, the disclosure describes a technology that may satisfy the QoS level required by V2X services by supporting unicast data transmission and reception based on a method for selecting RLC transmission mode and obtaining RLC configuration information for direct unicast sidelink communication between vehicle to everything (V2X) terminals in a wireless communication system.

In the following description, terms referring to signals, terms referring to channels, terms referring to control information, terms referring to network entities, terms referring to device elements, and the like are illustratively used for the sake of descriptive convenience. Therefore, the disclosure is not limited by the terms as described below, and other terms referring to subjects having equivalent technical meanings may be used.

In the disclosure, various embodiments will be described using terms defined in some communication standards (e.g., the 3rd generation partnership project (3GPP)), but they are only for the sake of illustration. Various embodiments of the disclosure may also be easily modified and applied to other communication systems through modifications.

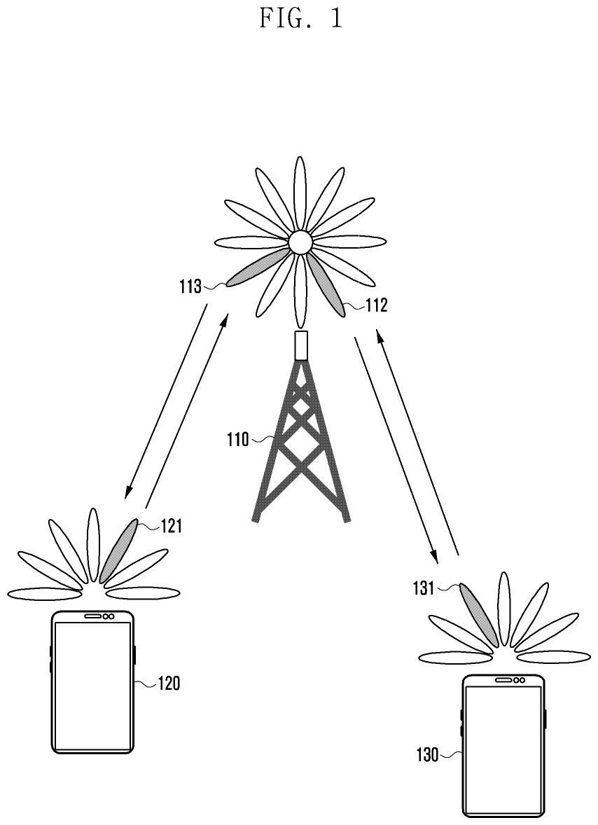

FIG. 1 illustrates a wireless communication system according to various embodiments of the disclosure.

Referring to FIG. 1, as some of nodes using a radio channel in a wireless communication system, a base station 110, a terminal 120, a terminal 130 are illustrated. Although FIG. 1 illustrates only one base station, other base stations identical or similar to the base station 110 may be further included. Although FIG. 1 illustrates two terminals 120 and 130, other terminals identical or similar to the terminals 120 and 130 may be further included.

The base station 110 is a network infrastructure that provides radio access to the terminals 120 and 130. The base station 110 has the coverage defined as a predetermined geographic area based on a distance at which a signal may be transmitted. In addition to base station, the base station 110 may be referred to as ‘access point (AP)’, ‘eNodeB (eNB)’, ‘5th generation node (5G node)’, ‘5gNodeB (gNodeB, gNB)’, ‘wireless point’, ‘transmission/reception point (TRP)’, or other terms having an equivalent technical meaning.

Each of the terminal 120 and the terminal 130 is a device used by a user and communicates with the base station 110 through a radio channel. In some cases, at least one of the terminal 120 and the terminal 130 may be operated without user involvement. That is, at least one of the terminal 120 and the terminal 130 is a device that performs machine type communication (MTC) and may not be carried by a user. In addition to terminal, each of the terminal 120 and the terminal 130 may be referred to as ‘user equipment (UE)’, ‘mobile station’, ‘subscriber station’, ‘remote terminal’, ‘wireless terminal’, ‘user device’, or other terms having an equivalent technical meaning.

The base station 110, the terminal 120, and the terminal 130 may transmit and receive wireless signals in the sub-6 GHz band and millimeter wave (mm Wave) band (e.g., 28 GHz, 30 GHz, 38 GHz, 60 GHz, etc.). In this case, in order to improve the channel gain, the base station 110, the terminal 120, and the terminal 130 may perform beamforming. Here, the beamforming may include transmission beamforming and reception beamforming. That is, the base station 110, the terminal 120, and the terminal 130 may provide directivity to the transmission signal or reception signal. To this end, the base station 110 and the terminals 120 and 130 may select serving beams 112, 113, 121, and 131 through a beam search or beam management procedure. After the serving beams 112, 113, 121, 131 are selected, subsequent communication may be performed through a resource in a Quasi co-located (QCL) relationship with the resource that transmitted the serving beams 112, 113, 121, and 131.

If the large-scale characteristics of the channel carrying the symbols on the first antenna port may be inferred from the channel carrying the symbols on the second antenna port, the first antenna port and the second antenna port may be evaluated to be in a QCL relationship. For example, the large-scale characteristics may include at least one of delay spread, Doppler spread, Doppler shift, average gain, average delay, and spatial receiver parameter.

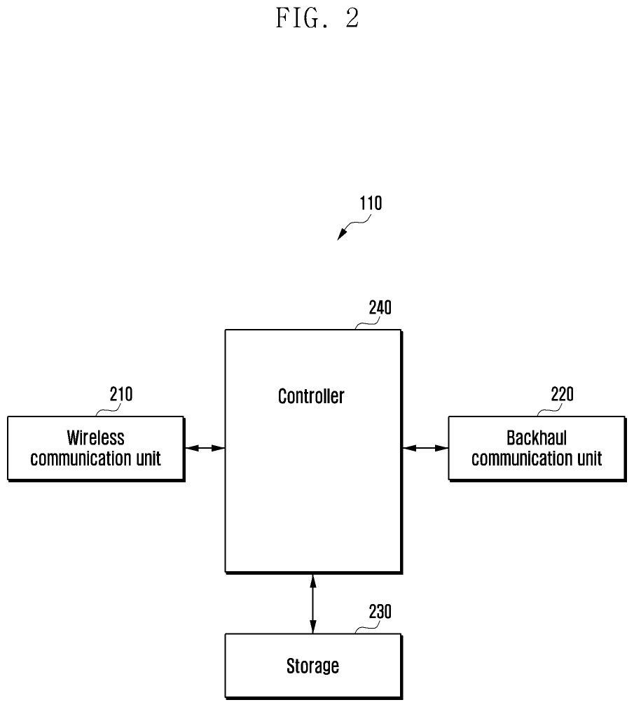

FIG. 2 illustrates a configuration of a base station in a wireless communication system according to various embodiments of the disclosure.

The configuration illustrated in FIG. 2 may be understood as a configuration of the base station 110. Terms such as ‘ . . . unit’, etc. used hereinafter refer to units that process at least one function or operation, which may be implemented by hardware or software, or a combination of hardware and software.

Referring to FIG. 2, the base station may include a wireless communication unit 210, a backhaul communication unit 220, a storage 230, and a controller 240.

The wireless communication unit 210 performs functions for transmitting and receiving signals through a radio channel. For example, the wireless communication unit 210 performs a conversion function between a baseband signal and a bit string according to the physical layer standard of the system. For example, when transmitting data, the wireless communication unit 210 generates complex symbols by encoding and modulating a transmission bit string. In addition, when receiving data, the wireless communication unit 210 restores the reception bit string through demodulation and decoding of the baseband signal.

In addition, the wireless communication unit 210 up-converts the baseband signal into a radio frequency (RF) band signal to transmit the RF band signal through an antenna, and down-converts the RF band signal received through the antenna into a baseband signal. To this end, the wireless communication unit 210 may include a transmission filter, a reception filter, an amplifier, a mixer, an oscillator, a digital to analog converter (DAC), an analog to digital converter (ADC), and the like. In addition, the wireless communication unit 210 may include a plurality of transmission and reception paths. Furthermore, the wireless communication unit 210 may include at least one antenna array composed of a plurality of antenna elements.

In terms of hardware, the wireless communication unit 210 may be composed of a digital unit and an analog unit, and the analog unit may be composed of a plurality of sub-units according to operating power, operating frequency, and the like. The digital unit may be implemented with at least one processor (e.g., a digital signal processor (DSP)).

The wireless communication unit 210 transmits and receives signals as described above. Accordingly, all or part of the wireless communication unit 210 may be referred to as a ‘transmitter’, a ‘receiver’ or a ‘transceiver’. In addition, in the following description, transmission and reception performed through a radio channel are used to refer to that the above-described processing is performed by the wireless communication unit 210.

The backhaul communication unit 220 provides an interface for communicating with other nodes in the network. That is, the backhaul communication unit 220 converts a bit string transmitted from the base station 110 to another node, for example, another access node, another base station, an upper node, a core network, etc., into a physical signal, and converts a physical signal received from the other node into a bit string.

The storage unit 230 stores data such as a basic program, an application program, and configuration information for operation of the base station 110. The storage unit 230 may be composed of a volatile memory, a non-volatile memory, or a combination of volatile and non-volatile memories. In addition, the storage unit 230 provides the stored data according to the request of the controller 240.

The controller 240 controls overall operations of the base station 110. For example, the controller 240 transmits and receives signals through the wireless communication unit 210 or the backhaul communication unit 220. In addition, the controller 240 writes and reads data in the storage unit 230. In addition, the controller 240 may perform functions of a protocol stack required by communication standards. According to another embodiment, the protocol stack may be included in the wireless communication unit 210. To this end, the controller 240 may include at least one processor.

According to various embodiments, the controller 240 may transmit radio resource control (RRC) configuration information to the terminals 120 and 130. For example, the controller 240 may control the base station 110 to perform operations according to various embodiments described below.

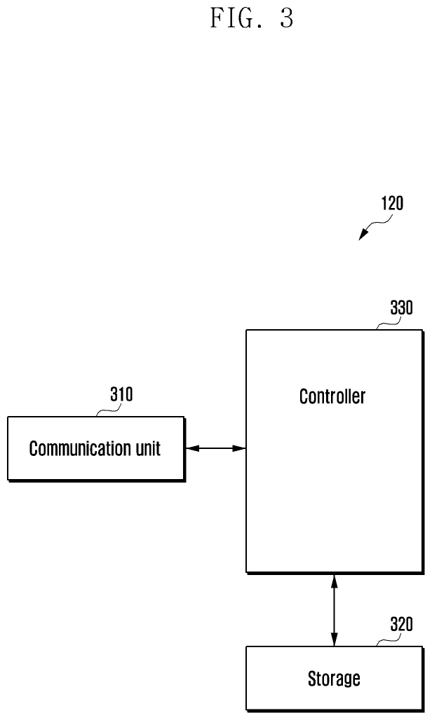

FIG. 3 illustrates a configuration of a terminal in a wireless communication system according to various embodiments of the disclosure.

The configuration illustrated in FIG. 3 may be understood as a configuration of the terminal 120 or the terminal 120. Terms such as ‘ . . . unit’, etc. used below refer to units that process at least one function or operation, which may be implemented by hardware or software, or a combination of hardware and software.

Referring to FIG. 3, the terminal may include a communication unit 310, a storage unit 320, and a controller 330.

The communication unit 310 performs functions for transmitting and receiving signals through a radio channel. For example, the communication unit 310 performs a conversion function between a baseband signal and a bit string according to the physical layer standard of the system. For example, when transmitting data, the communication unit 310 generates complex symbols by encoding and modulating a transmission bit string. In addition, when receiving data, the communication unit 310 restores the reception bit string through demodulation and decoding of the baseband signal. In addition, the communication unit 310 up-converts the baseband signal into a radio frequency (RF) band signal to transmit the RF band signal through an antenna, and down-converts the RF band signal received through the antenna into a baseband signal. For example, the communication unit 310 may include a transmission filter, a reception filter, an amplifier, a mixer, an oscillator, a DAC, an ADC, and the like.

In addition, the communication unit 310 may include a plurality of transmission and reception paths. Furthermore, the communication unit 310 may include at least one antenna array composed of a plurality of antenna elements. In terms of hardware, the communication unit 310 may include a digital circuit and an analog circuit (e.g., a radio frequency integrated circuit (RFIC)). Here, the digital circuit and the analog circuit may be implemented in one package. In addition, the communication unit 310 may include multiple RF chains. Furthermore, the communication unit 310 may perform beamforming.

In addition, the communication unit 310 may include different communication modules to process signals of different frequency bands. Furthermore, the communication unit 310 may include a plurality of communication modules to support a plurality of different radio access technologies. For example, the different radio access technologies may include Bluetooth low energy (BLE), wireless fidelity (Wi-Fi), Wi-Fi gigabyte (WiGig), cellular networks (e.g., long-term evolution (LTE), and the like. In addition, the different frequency bands may include a super high frequency (SHF) (e.g., 2.5 GHz and 5 GHz) band and a millimeter wave (e.g., 60 GHz) band.

The communication unit 310 transmits and receives signals as described above. Accordingly, all or part of the communication unit 310 may be referred to as a ‘transmitter’, a ‘receiver’ or a ‘transceiver’. In addition, in the following description, transmission and reception performed through a radio channel are used to refer to that the above-described processing is performed by the communication unit 310.

The storage unit 320 stores data such as a basic program, an application program, and configuration information for operation of the terminal 120. The storage unit 320 may be composed of a volatile memory, a non-volatile memory, or a combination of volatile and non-volatile memories. In addition, the storage unit 320 provides the stored data according to the request of the controller 330.

The controller 330 controls overall operations of the terminal. For example, the controller 330 transmits and receives signals through the communication unit 310. In addition, the controller 330 writes and reads data in the storage unit 320. In addition, the controller 330 may perform functions of a protocol stack required by communication standards. To this end, the controller 330 may include at least one processor or microprocessor, or may be a part of the processor. In addition, a part of the communication unit 310 and the controller 330 may be referred to as a communication processor (CP).

According to various embodiments, when the terminal 120 configures a sidelink unicast session with another terminal or transmits a sidelink groupcast and broadcast to other terminals, the controller 330 may perform a process of obtaining resource allocation information required for sidelink transmission from the base station, a process of determining available resources among resources configured to be used by the terminal 120, and a process of determining that information on resources provided in the message after receiving a sidelink control information (SCI) message for reservation of resources transmitted by another terminal is a resource that the terminal 120 is using, is scheduled to use, or is a resource reserved by other terminals including the terminal. For example, the controller 330 may control the terminal to perform operations according to various embodiments described below.

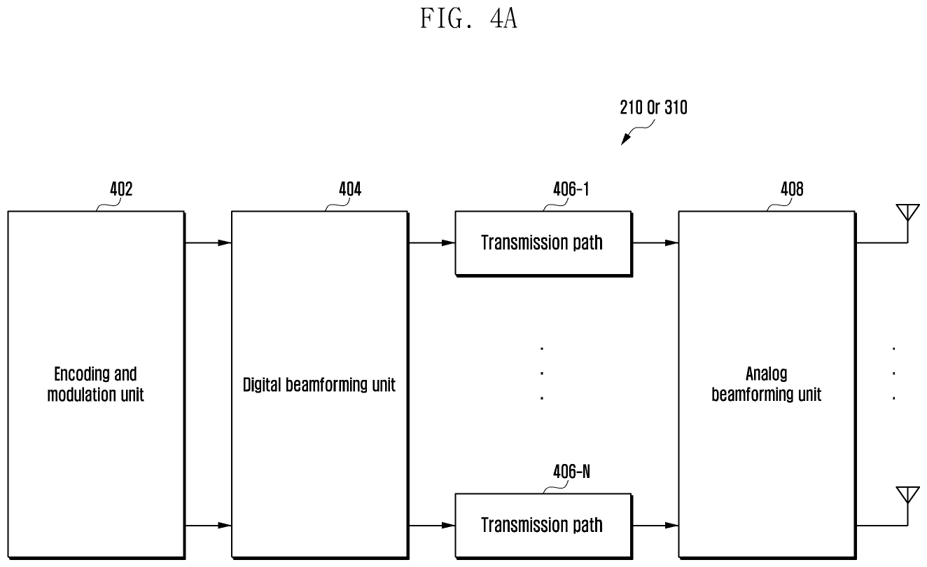

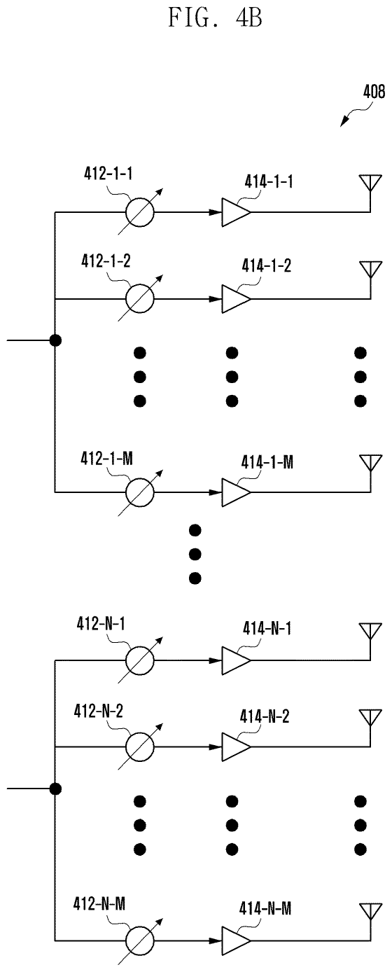

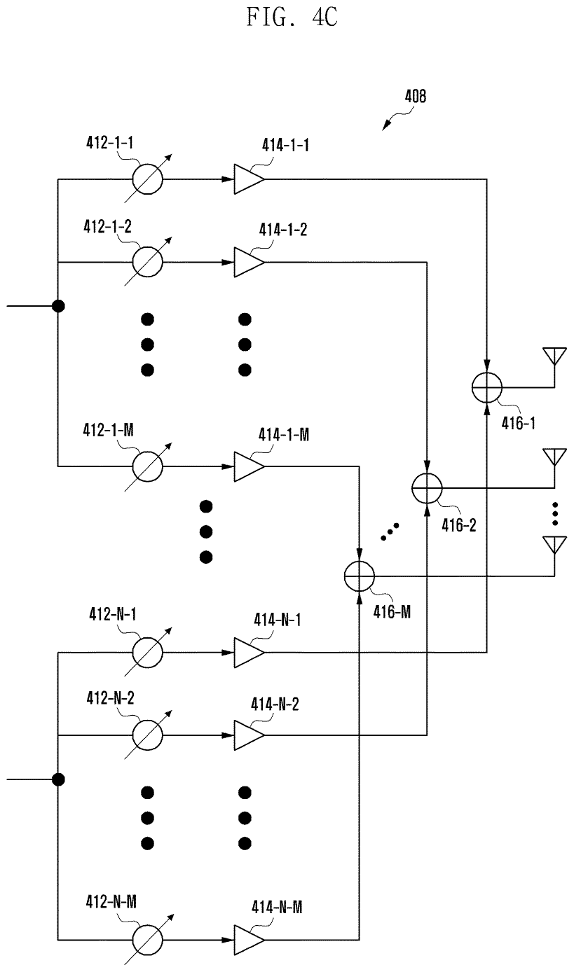

FIGS. 4A to 4C illustrate configurations of a communication unit in a wireless communication system according to various embodiments of the disclosure.

FIGS. 4A to 4C illustrate an example of the detailed configuration of the wireless communication unit 210 of FIG. 2 or the communication unit 310 of FIG. 3. Specifically, FIGS. 4A to 4C illustrate components for performing beamforming as part of the wireless communication unit 210 of FIG. 2 or the communication unit 310 of FIG. 3.

Referring to FIG. 4A, the wireless communication unit 210 or communication unit 310 may include an encoding and modulation unit 402, a digital beamforming unit 404, a plurality of transmission paths 406-1 to 406-N, and an analog beamforming unit 408.

The encoding and modulation unit 402 performs channel encoding. For channel encoding, at least one of a low density parity check (LDPC) code, a convolution code, and a polar code may be used. The encoding and modulation unit 402 generates modulation symbols by performing constellation mapping.

The digital beamforming unit 404 performs beamforming on digital signals (e.g., modulation symbols). To this end, the digital beamforming unit 404 multiplies the modulation symbols by beamforming weights. Here, the beamforming weights are used to change the size and phase of the signal, and may be referred to as a ‘precoding matrix’ or a ‘precoder’. The digital beamforming unit 404 outputs digital beamformed modulation symbols to a plurality of transmission paths 406-1 to 406-N. In this case, according to the multiple input multiple output (MIMO) transmission technique, modulated symbols may be multiplexed or the same modulated symbols may be provided to a plurality of transmission paths 406-1 to 406-N.

A plurality of transmission paths 406-1 to 406-N convert digital beamformed digital signals into analog signals. To this end, each of the plurality of transmission paths 406-1 to 406-N may include an inverse fast forward Fourier transform (IFFT) calculator, a cyclic prefix (CP) inserter, a DAC, and an up-converter. The CP inserter is for the orthogonal frequency division multiplexing (OFDM) method and may be excluded when other physical layer methods (e.g., filter bank multi-carrier (FBMC) are applied. That is, the plurality of transmission paths 406-1 to 406-N provide an independent signal processing process for a plurality of streams generated through digital beamforming. However, depending on the implementation method, some of the components of the plurality of transmission paths 406-1 to 406-N may be commonly used.

The analog beamforming unit 408 performs beamforming on analog signals. To this end, the digital beamforming unit 404 multiplies the analog signals by beamforming weights. Here, the beamforming weights are used to change the size and phase of the signal. Specifically, depending on the connection structure between the plurality of transmission paths 406-1 to 406-N and the antennas, the analog beamforming unit 408 may be configured as illustrated in FIG. 4B or FIG. 4C.

Referring to FIG. 4B, signals input to the analog beamforming unit 408 go through phase/magnitude conversion and amplification, and are transmitted through antennas. In this case, the signal of each path is transmitted through different antenna sets, that is, antenna arrays. Looking at the processing of the signal input through the first path, the signal is converted into a signal sequence having different or the same phase/magnitude by the phase/magnitude converters 412-1 to 412-1-M, amplified by the amplifiers 414-1 to 414-1-M, and transmitted through the antennas.

Referring to FIG. 4C, signals input to the analog beamforming unit 408 go through phase/magnitude conversion and amplification, and are transmitted through antennas. In this case, the signal of each path is transmitted through the same antenna sets, that is, antenna arrays. Looking at the processing of the signal input through the first path, the signal is converted into a signal sequence having different or the same phase/magnitude by the phase/magnitude converters 412-1-1 to 412-1-M, and amplified by the amplifiers 414-1-1 to 414-1-M. In addition, to be transmitted through one antenna array, the amplified signals are summed by the summing units 416-1-1 to 416-1-M based on the antenna element and then transmitted through the antennas.

FIG. 4B illustrates an example in which an independent antenna array for each transmission path is used, and FIG. 4C illustrates an example in which transmission paths share one antenna array. However, according to another embodiment, some transmission paths may use an independent antenna array, and the other transmission paths may share one antenna array. Furthermore, according to another embodiment, by applying a switchable structure between transmission paths and antenna arrays, a structure that may adaptively change according to the situation may be used.

V2X services may be divided into basic safety services and advanced services. The basic safety services may correspond to vehicle notification (CAM or BSM) services as well as detailed services such as left turn notification services, front car crash warning services, emergency vehicle approach notification services, front obstacle warning services, intersection signal information services, and the like, and designed to transmit and receive V2X information by using a broadcast transmission method and may be supported by using the existing 4G-based V2X communication method. The advanced services not only enhances QoS requirements over the basic safety services, but also requires a method to transmit and receive V2X information by using unicast and groupcast transmission methods so that V2X information may be transmitted and received between two vehicles within a specific vehicle group. The advanced services may correspond to detailed services such as platooning services, autonomous driving services, remote driving services, extended sensor-based V2X services, and the like.

For terminal-to-terminal communication services in next-generation wireless mobile communication, the base station may allocate resources required for terminal-to-terminal communication by using one of the following two sidelink resource allocation modes.

1) Mode 1. A mode in which the base station configures the transmission and reception resources used for sidelink communication of the terminal as a radio resource control (RRC) reconfiguration message (RRCReconfiguration) and indicates the transmission resources through the RRC reconfiguration message (RRCReconfiguration) or downlink control information (DCI) message, and the terminal performs sidelink communication through the transmission resources indicated by the base station.

2) Mode 2. A mode in which the base station transmits the transmission and reception resource pool used for sidelink communication of the terminal through the configuration information (RRC reconfiguration message (RRCReconfiguration), V2X service broadcast message (system information block (SIB)), or pre-configuration), and the terminal selects a transmission resource within the transmission resource pool configured by the base station by using a sensing-based or random selection method to perform sidelink communication.

When the terminal performing sidelink communication is within the coverage of the base station and is in the RRC connected state (RRC-Connected), the transmission and reception resource pool configured with the RRC reconfiguration message (RRCReconfiguration) may be used. When the terminal is within the coverage of the base station and is in the RRC disconnected state (RRC-Idle or RRC-Inactive), the transmission and reception resource pool configured with the V2X service broadcast message (SIB) may be used. When the terminal is outside the coverage of the base station, the transmission and reception resource pool configured with the pre-configuration may be used.

The disclosure deals with a solution for improving the performance of sidelink communication using cooperation between terminals (inter-UE coordination), which is a sub-goal of improved resource allocation (Resource allocation enhancement) among the working item description (WID) items for improved sidelink (NR sidelink enhancement) expected to be included in Release 17 of 3GPP.

Radio access network (RAN) 1 working group (WG) of 3GPP agreed to use at least two types of cooperation methods between terminals (inter-UE coordination) as follows.
1) The terminal that transmits an explicit request for cooperation between terminals is the terminal-B (UE-B). The terminal that receives the explicit request transmitted by UE-B and transmits inter-UE coordination information to the UE-B is a terminal-A (UE-A). The UE-A transmits a set of preferred or non-preferred resources to the UE-B. The UE-B reflects the received inter-UE coordination information in resource selection or resource reselection.
2) The UE-B is the terminal that transmits sidelink control information (SCI) for resource reservation and then receives inter-UE coordination information of conflict (collision) detection between corresponding resources transmitted by the UE-A, and reflects the corresponding information in resource reselection. The UE-A is the terminal that transmits inter-UE coordination information to the UE-B in the case of determining that the resource indicated by the sidelink control information (SCI) is a resource in use or scheduled to be used by the UE-A or reserved by other terminals including the terminal when the UE-B transmits sidelink control information (SCI) for resource reservation.

Resource conflicts (collisions) in the examples and embodiments described below refers to a case in which it is determined that the resource indicated in the sidelink control information (SCI) is in use or scheduled to be used by the UE-A, or is a resource reserved by other terminals including the terminal, or an equivalent situation.

According to various embodiments, the disclosure presents a method for flexibly coping with the requirements of a service and an operator under various conditions by providing differentiation in consideration of priority of transmitted data and destination/non-destination terminals through configuring the condition that the UE-A transmits inter-UE coordination information in the inter-UE coordination scheme 2, which may be used in sidelink resource allocation mode 2 and the condition for using the inter-UE coordination information received by the UE-B.

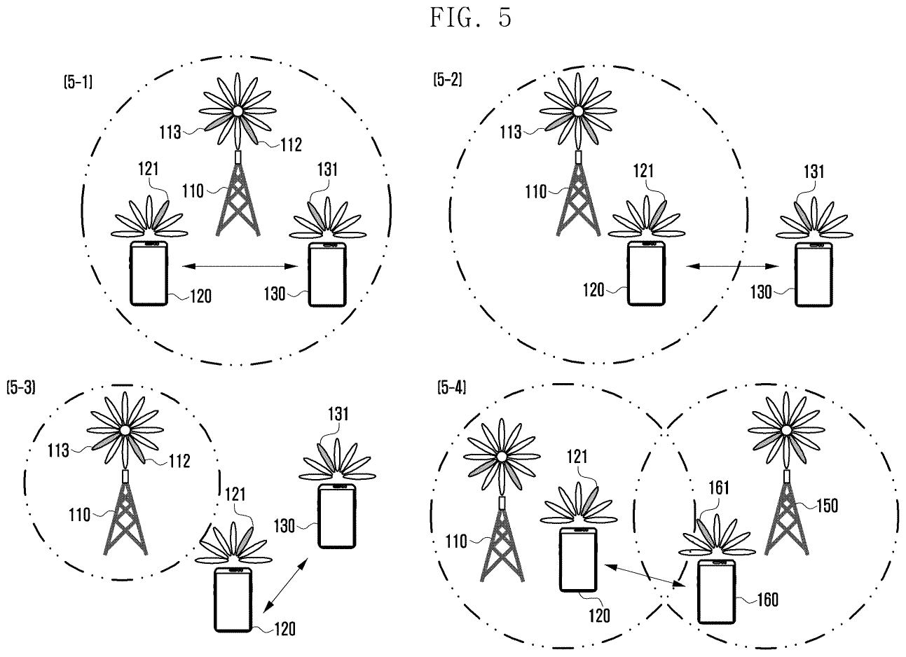

FIG. 5 illustrates a situation in which direct communication between terminals is performed using unicast, groupcast, or broadcast method according to various embodiments of the disclosure.

Referring to FIG. 5, four scenarios to which embodiments of the disclosure may be applied are illustrated.

In the scenario illustrated in (5-1), the first terminal 120 and the second terminal 130 within the coverage of the base station 110 may perform direct communication in unicast, group cast, and broadcast methods. According to an embodiment of the disclosure, the first terminal 120 and the second terminal 130 may exchange inter-UE coordination information.

In the scenario illustrated in (5-2), the first terminal 120 within the coverage of the base station 110 and the second terminal 130 that is not within the coverage of the base station may perform direct communication in unicast, group cast, and broadcast methods. According to an embodiment of the disclosure, the first terminal 120 and the second terminal 130 may exchange inter-UE coordination information.

In the scenario illustrated in (5-3), the first terminal 120 and the second terminal 130 that are not within the coverage of the base station 110 may perform direct communication in unicast, group cast, and broadcast methods. According to an embodiment of the disclosure, the first terminal 120 and the second terminal 130 may exchange inter-UE coordination information.

In the scenario illustrated in (5-4), the first terminal 120 within the coverage of the first base station 110 and the second terminal 160 that is within the coverage of the second base station 150 may perform direct communication in unicast, group cast, and broadcast methods. According to an embodiment of the disclosure, the first terminal 120 and the second terminal 160 may exchange inter-UE coordination information.

Although not described in FIG. 5, the disclosure may be implemented without limitation due to any terminal being in an RRC connected state within the coverage of the base station, an RRC inactive state (RRC Idle or RRC Inactive), or an out of coverage state.

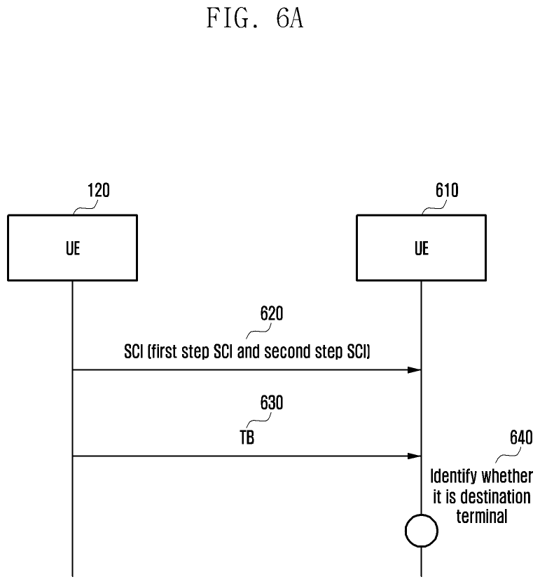

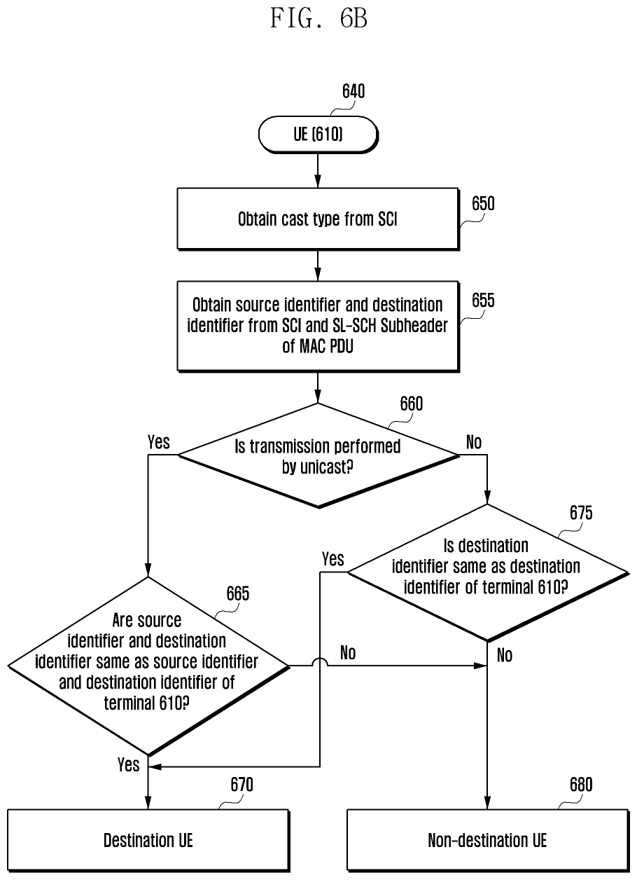

FIGS. 6A and 6B illustrate a direct communication procedure between terminals, which are referenced in the disclosure, using sidelink unicast, groupcast, and broadcast methods and a method for identifying whether a destination terminal is present.

Referring to FIGS. 6A and 6B, a process 640 for identifying whether a terminal 610 receiving the SCI 620 and the transport block (TB) 630 of the terminal 120 performing sidelink communication is a destination or non-destination terminal is included in the transmission for each of the four scenarios in FIG. 5. This process may be performed by comparing information indicated by a sidelink-shared channel (SL-SCH) subheader of the medium access control (MAC) protocol data unit (PDU) of the SCI 620 and the TB 630 transmitted by the terminal 120 with information held by the terminal 610 that received the indicated information. Sidelink control information (SCI) may be transmitted in two stages, and the SCI of the first stage (1^{st}-stage SCI) is used for scheduling the SCI of the second stage (2^{nd}-stage SCI) and the sidelink-shared channel (SL-SCH), including the information described below. Description of other information included in the SCI of the first stage in addition to the information described below will be omitted in the disclosure.
Priority, frequency resource assignment, time resource assignment, resource reservation period, 2^{nd}-stage SCI format.
The priority indicates the highest priority among the sidelink logical channel or MAC control element (CE) included in the MAC PDU of the TB to be transmitted.
Frequency resource assignment information indicates the lowest sub-channels of resources reserved by the corresponding sidelink control information (SCI). Depending on the upper layer configurations, up to 3 resources, including the first SCI, may be reserved.
Time resource assignment information indicates the logical slot offset of resources reserved by the corresponding SCI.
The resource reservation period indicates that the resource indicated by the frequency and resource assignment information is reserved from the reserved resource in a semi-static manner after the corresponding period. If the resource reserved by the SCI is no longer used, the corresponding information is not included.
The SCI format of the second stage indicates that SCI format 2-A or SCI format 2-B is used.
The SCI of the second stage may be the SCI format 2-A or SCI format 2-B, and the SCI format 2-A includes the following information. Description of other information included in the SCI format 2-A will be omitted in the disclosure.
A part (lower 8 bits (8 LSB) out of 24 bits) of the source identifier (Source Layer-2 ID), a part (lower 16 bits (16 LSB) out of 24 bits) of the destination identifier (Destination Layer-2 ID), and a cast type indicator
The source identifier is 24 bits, and the part indicated by SCI is the lower 8 bits of the 24 bits.
The destination identifier is 24 bits, and the part indicated by SCI is the lower 16 bits of the 24 bits.

The cast type indicator indicates one of unicast, groupcast (when using HARQ ACK/NACK), groupcast (when using only HARQ NACK), or broadcast.

The SCI format 2-B includes the following information. Description of other information included in the SCI format 2-B will be omitted in the disclosure.
A part (lower 8 bits (8 LSB) out of 24 bits) of the source identifier (Source Layer-2 ID), a part (lower 16 bits (16 LSB) out of 24 bits) of the destination identifier (Destination Layer-2 ID), a zone ID, and a communication range requirement.
The Source Layer-2 ID is 24 bits, and the part indicated by SCI is the lower 8 bits of the 24 bits.
The Destination Layer-2 ID is 24 bits, and the part indicated by SCI is the lower 16 bits of the 24 bits.
The terminal that has received the zone identifier and communication range requirements may transmit HARQ NACK by using location information according to configurations when the distance between the center of the nearest zone and the terminal's location is within the communication range requirements.

For convenience of explanation, the SCI of the first stage and the SCI of the second stage will be integrated and referred to as SCI.

The SL-SCH subheader of the MAC PDU includes the following information. Description of other information included in the SL-SCH subheader of the MAC PDU will be omitted in the disclosure.
A part (higher 16 bits (16 MSB) out of 24 bits) of the source identifier (Source Layer-2 ID) and a part (higher 8 bits (8 MSB) out of 24 bits) of the destination identifier (Destination Layer-2 ID)
The Source Layer-2 ID is 24 bits, and the part indicated by SL-SCH subheader of the MAC PDU is the higher 16 bits of the 24 bits.
The Destination Layer-2 ID is 24 bits, and the part indicated by SL-SCH subheader of the MAC PDU is the higher 8 bits of the 24 bits.

The terminal 610, which has received the SCI 620 and TB 630 transmitted by the terminal 120, may obtain the cast type, source identifier, and destination identifier from the SCI and the SL-SCH subheader of MAC PDU through steps 650 and 655, and determine whether the terminal is a destination terminal or non-destination terminal through the procedure below (640).

When the cast type is determined to be unicast in step 660, the terminal 610 may proceed to step 665 to determine whether the source identifier and destination identifier obtained in step 655 are the same as the destination identifier and source identifier of the unicast link held by the terminal 610. If they are identical, the terminal 610 may proceed to step 670 to determine the terminal is a destination terminal. On the other hand, if they are not identical, the terminal 610 may proceed to step 680 to determine the terminal is a non-destination terminal. Detailed descriptions of the connection and management of unicast links will be omitted in the disclosure.

When the cast type is determined to be groupcast or broadcast in step 660, the terminal 610 may proceed to step 675 to determine whether the destination identifier obtained in step 655 is the same as the destination identifier of the groupcast or broadcast held by the terminal 610. If they are identical, the terminal 610 may proceed to step 670 to determine the terminal is a destination terminal. On the other hand, if they are not identical, the terminal 610 may proceed to step 680 to determine the terminal is a non-destination terminal. Detailed descriptions of destination identifier management of the broadcast and group cast will be omitted in the disclosure.

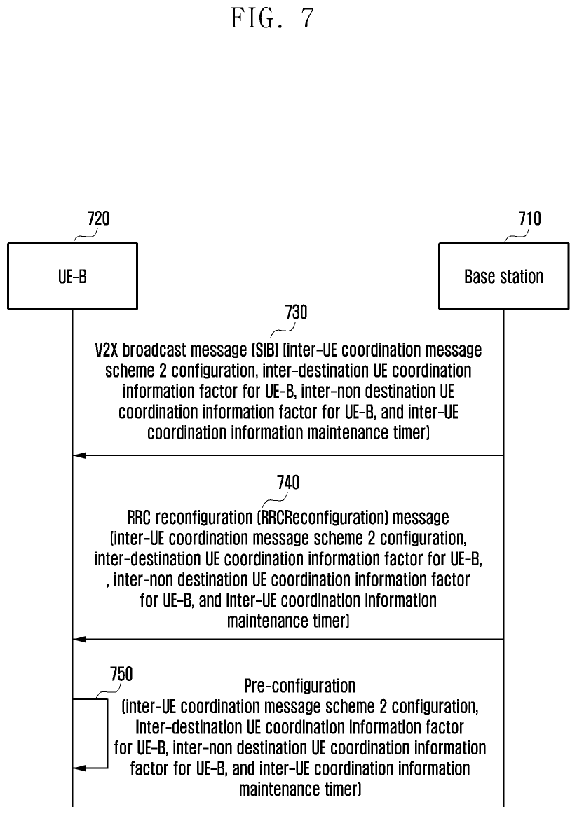

FIG. 7 illustrates a method of providing UE-B with configurations for inter-UE coordination scheme 2 according to various embodiments of the disclosure.

Referring to FIG. 7, for configuration of the inter-UE coordination scheme 2, a base station 710 may provide a UE-B 720 with at least one of the following information through a V2X broadcast message (SIB) (step 730) and/or an RRC reconfiguration (RRCReconfiguration) message (step 740).

In addition, at least one of the following information may be pre-configured in the V2X layer of the UE-B 720 as in step 750.
inter-UE coordination scheme 2 configuration, PC5 QOS flow and sidelink data radio bearer (SL-DRB) mapping information, sidelink data radio bearer (SL-DRB) information, sidelink logical channel information, inter-destination UE coordination information for the UE-B 720, inter-non-destination UE coordination information for the UE-B 720, and inter-UE coordination information maintenance timer.
In case of providing the inter-UE coordination scheme 2 configuration, when receiving inter-UE coordination information provided by the UE-A through the inter-UE coordination scheme 2, the UE-B 720 may recognize that the resources reserved through the SCI have conflicted (collided) and perform a transmission resource reselection (TX resource selection). In this case, reselecting candidate resources to be reselected may be performed by excluding resources reserved by the UE-B 720 and avoiding resources in which a conflict has occurred.
In case of providing the PC5 QoS flow and sidelink data radio bearer (SL-DRB) mapping information, the UE-B 720 may store the corresponding PC5 QoS Flow identifier, an inter-destination UE coordination message factor for the UE-B 720, and an inter-non-destination UE coordination message factor for the UE-B 720.
In case of providing the sidelink data radio bearer (SL-DRB) information, the UE-B 720 may store the corresponding SL-DRB identifier, an inter-destination UE coordination message factor for the UE-B 720, and an inter-non-destination UE coordination message factor for the UE-B 720.
In case of providing the sidelink logical channel information, the UE-B 720 may store the corresponding logical channel, an inter-destination UE coordination message factor for the UE-B 720, and an inter-non-destination UE coordination message factor for the UE-B 720.
The inter-destination UE coordination message factor for the UE-B 720 is the probability of whether the corresponding information is used when the UE-B 720 receives the inter-UE coordination message from the destination terminal, UE-A. This information may be expressed, for example, as follows.

IUC-UEBDestinationFactorScheme2-r17xy ENUMERATED {p00, p05, p10, p15, p20, p25, p30, p40, p50, p60, p70, p75, p80, p85, p90, p95},
The inter-non-destination UE coordination message factor for the UE-B 720 is the probability of whether the corresponding information is used when the UE-B 720 receives the inter-UE coordination message from the non-destination terminal, UE-A. This information may be expressed, for example, as follows.

IUC-UEBNonDestinationFactorScheme2-r17xy ENUMERATED {p00, p05, p10, p15, p20, p25, p30, p40, p50, p60, p70, p75, p80, p85, p90, p95},

In the above factors, p00 may be a probability of 0, and p 95 may be a probability of 0.95. If the information is not transmitted, the UE-B 720 may apply a probability of 1. Of course, the value may not be configured only in a probability unit of 0.05, but may be provided flexibly in a narrower or wider range.

The inter-UE coordination information maintenance timer represents a timer for maintaining inter-UE coordination information received by the UE-B 720 from the UE-A. This information may be expressed, for example, as follows.

IUC-KeepTimerScheme2-r17xy INTEGER (1 . . . xxxx)

The above value represents units of 1/1000 of a second (millisecond, ms), where 1 means 1 ms. Of course, the value may not be configured only in units of 1 ms, but may be flexibly provided in units of smaller or larger.

According an embodiment, if the timer is not configured or needs to be adjusted according to the needs of the terminal, the inter-UE coordination information maintenance timer received by the UE-B 720 from the UE-A may be determined by using remaining packet delivery budget (remaining PDB). The PDB is the packet delay budget included in the Sidelink QoS profile and represents the upper limit of delay time that packets may experience. The remaining PDB is a value maintained and managed by the terminal, and may be easily identified by those skilled in the art, so a detailed description thereof will be omitted in the disclosure.

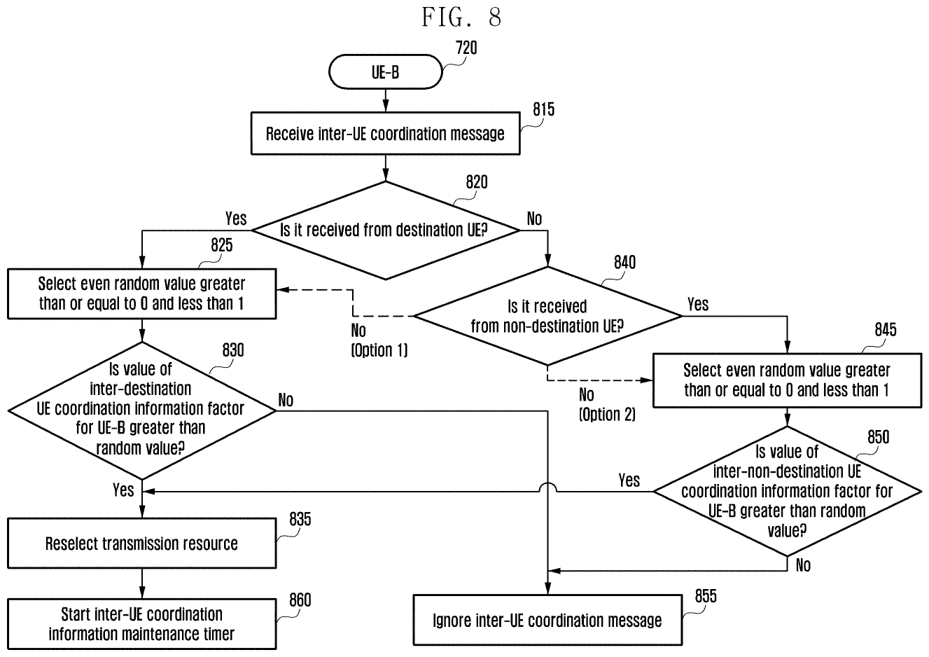

FIG. 8 illustrates the operation of UE-B's inter-UE coordination scheme 2 according to various embodiments of the disclosure.

Referring to FIG. 8, the UE-B 720 is configured to perform the operation of UE-B's inter-UE coordination scheme 2 according to configurations of FIG. 7 from the base station or pre-configuration, and operate as follows according to the configurations provided above when an inter-UE coordination message has been received from the UE-A in step 815 for the resources reserved through SCI for sidelink transmission.
A PQFI mapped to an SL-DRB using a sidelink logical channel included in the MAC PDU to be transmitted and inter-destination UE coordination information or inter-non destination UE coordination information for the UE-B 720 may have been configured. In step 820, the UE-B 720 may determine whether the inter-UE coordination message has been received from the UE-A that is the destination terminal. When it is recognized that the inter-UE coordination message has been received from the UE-A that is the destination terminal in step 820, the UE-B 720 may select an even random value greater than or equal to 0 and less than 1 in step 825. In addition, in step 830, the UE-B 720 may determine whether the value of the inter-destination UE coordination information factor for the UE-B 720 is greater than the selected random value. If the value of the inter-UE coordination information factor for the UE-B 720 is greater than the selected random value, the UE-B 720 may perform transmission (TX) resource selection in step 835. If it is determined in step 820 that the inter-UE coordination message has not been received from the UE-A that is a destination terminal, the UE-B 720 may determine whether the inter-UE coordination message has been received from UE-A 8xx that is a non-destination terminal in step 840. As a result of the determination, it is recognized that the inter-UE coordination message has been received from UE-A 8xx that is a non-destination terminal in step 840, the UE-B 720 may select an even random value greater than or equal to 0 and less than 1 in step 845. In addition, in step 850, the UE-B 720 may determine whether the value of the inter-destination UE coordination information factor for the UE-B 720 is greater than the selected random value. If the value of the inter-destination UE coordination information factor for the UE-B 720 is greater than the selected random value, the UE-B 720 may perform transmission (TX) resource selection in step 835. If it is impossible to distinguish that the inter-UE coordination message has been received from the destination terminal or non-destination terminal in step 820 and/or 840, the UE-B 720 may perform the above operation assuming that the message has been received from the destination terminal (option 1) or non-destination terminal (option 2). That is, if it is assumed that the message is received from the destination terminal (option 1), the UE-B 720 may select an even random value greater than or equal to 0 and less than 1 in step 825, and compare the value selected in step 825 with the value of the inter-destination UE coordination information factor for the UE-B 720 to reselect the transmission resource according to step 835 or ignore the inter-UE coordination message in step 855. In addition, if it is assumed that the message is received from the non-destination terminal (option 2), the UE-B 720 may select an even random value greater than or equal to 0 and less than 1 in step 845, and compare the value selected in step 845 with the value of the inter-destination UE coordination information factor for the UE-B 720 in step 850 to reselect the transmission resource according to step 835 or ignore the inter-UE coordination message in step 855. If an inter-destination UE coordination information factor or an inter-non-destination UE coordination information factor for the UE-B 720 for two or more PQFIs is configured, the UE-B 720 may select the largest value among the factor values. In steps 830 and 850, if the value of the inter-destination UE coordination information factor or inter-non-destination UE coordination information factor for the UE-B 720 is less than the selected random value, the UE-B 720 may proceed to step 855 to ignore the inter-UE coordination message.
An SL-DRB identifier using a sidelink logical channel included in the MAC PDU to be transmitted and inter-destination UE coordination information or inter-non destination UE coordination information for the UE-B 720 may have been configured. In step 820, the UE-B 720 may determine whether the inter-UE coordination message has been received from the UE-A that is the destination terminal. When it is recognized that the inter-UE coordination message has been received from the UE-A that is the destination terminal in step 820, the UE-B 720 may select an even random value greater than or equal to 0 and less than 1 in step 825. In addition, in step 830, the UE-B 720 may determine whether the value of the inter-destination UE coordination information factor for the UE-B 720 is greater than the selected random value. If the value of the inter-UE coordination information factor for the UE-B 720 is greater than the selected random value, the UE-B 720 may perform transmission (TX) resource selection in step 835. If it is determined in step 820 that the inter-UE coordination message has not been received from the UE-A that is a destination terminal, the UE-B 720 may determine whether the inter-UE coordination message has been received from UE-A 8xx that is a non-destination terminal in step 840. As a result of the determination, when it is recognized that the inter-UE coordination message has been received from UE-A 8xx that is a non-destination terminal in step 840, the UE-B 720 may select an even random value greater than or equal to 0 and less than 1 in step 845. In addition, in step 850, the UE-B 720 may determine whether the value of the inter-destination UE coordination information factor for the UE-B 720 is greater than the selected random value. If the value of the inter-destination UE coordination information factor for the UE-B 720 is greater than the selected random value, the UE-B 720 may perform transmission (TX) resource selection in step 835. If it is impossible to distinguish that the inter-UE coordination message has been received from the destination terminal or non-destination terminal in step 820 and/or 840, the UE-B 720 may perform the above operation assuming that the message has been received from the destination terminal (option 1) or non-destination terminal (option 2). If an inter-destination UE coordination information factor or an inter-non-destination UE coordination information factor for the UE-B 720 for two or more SL-DRBs is configured, the UE-B 720 may select the largest value among the factor values. In steps 830 and 850, if the value of the inter-destination UE coordination information factor or inter-non-destination UE coordination information factor for the UE-B 720 is less than the selected random value, the UE-B 720 may proceed to step 855 to ignore the inter-UE coordination message.
A sidelink logical channel included in the MAC PDU to be transmitted and inter-destination UE coordination information or inter-non destination UE coordination information for the UE-B 720 may have been configured. In step 820, the UE-B 720 may determine whether the inter-UE coordination message has been received from the UE-A that is the destination terminal. When it is recognized that the inter-UE coordination message has been received from the UE-A that is the destination terminal in step 820, the UE-B 720 may select an even random value greater than or equal to 0 and less than 1 in step 825. In addition, in step 830, the UE-B 720 may determine whether the value of the inter-destination UE coordination information factor for the UE-B 720 is greater than the selected random value. If the value of the inter-UE coordination information factor for the UE-B 720 is greater than the selected random value, the UE-B 720 may perform transmission (TX) resource selection in step 835. If it is determined in step 820 that the inter-UE coordination message has not been received from the UE-A that is a destination terminal, the UE-B 720 may determine whether the inter-UE coordination message has been received from UE-A 8xx that is a non-destination terminal in step 840. As a result of the determination, when it is recognized that the inter-UE coordination message has been received from UE-A 8xx that is a non-destination terminal in step 840, the UE-B 720 may select an even random value greater than or equal to 0 and less than 1 in step 845. In addition, in step 850, the UE-B 720 may determine whether the value of the inter-destination UE coordination information factor for the UE-B 720 is greater than the selected random value. If the value of the inter-destination UE coordination information factor for the UE-B 720 is greater than the selected random value, the UE-B 720 may perform transmission (TX) resource selection in step 835. If it is impossible to distinguish that the inter-UE coordination message has been received from the destination terminal or non-destination terminal in step 820 and/or 840, the UE-B 720 may perform the above operation assuming that the message has been received from the destination terminal (option 1) or non-destination terminal (option 2). If an inter-destination UE coordination information factor or an inter-non-destination UE coordination information factor for the UE-B 720 for two or more sidelink logical channels is configured, the UE-B 720 may select the largest value among the factor values. In steps 830 and 850, if the value of the inter-destination UE coordination information factor or inter-non-destination UE coordination information factor for the UE-B 720 is less than the selected random value, the UE-B 720 may proceed to step 855 to ignore the inter-UE coordination message.
When performing transmission (TX) resource reselection through the above embodiment, the UE-B 720 may operate an inter-UE coordination information maintenance timer for each resource in step 860. If the timer is operating, the UE-B 720 may exclude the corresponding resource from resource candidates in subsequent resource reselection. When the UE-B 720 receives additional inter-UE coordination information for a resource for which the inter-UE coordination information maintenance timer is operating, the UE-B 720 may restart the inter-UE coordination information maintenance timer. When the inter-UE coordination information maintenance timer expires, the UE-B 720 may stop the timer and reselect the resource that has been excluded in the subsequent resource reselection. In addition to expiring the inter-UE coordination information maintenance timer by the configured time, the UE-B 720 may terminate the inter-terminal cooperative information maintenance timer and reselect the excluded resource again in at least one of the following situations.
When it is determined that the unicast link between the UE-B 720 and UE-A is broken or no longer in use, the corresponding timer may be terminated when the inter-terminal cooperative information maintenance timer received from the destination UE-A is operating.
When reselecting resources of the UE-B 720, if it is impossible to select enough resources for TB to be transmitted due to the influence of the received inter-terminal cooperative information, the timer may be terminated according to the priority included in the SCI that reserved the resource for which the inter-terminal cooperative information maintenance timer is operating, and resource reselection may be performed from resource candidates including the corresponding resource.
When the transmission resource pool of the UE-B 720 has been changed, and some or all of the resources indicated by the inter-terminal cooperative information received from the UE-A do not belong to the changed resource pool, the timer for the resources that no longer belong to the changed resource pool may be terminated.
When the UE-B 720 no longer performs sidelink communication, timers for all resources may be terminated.

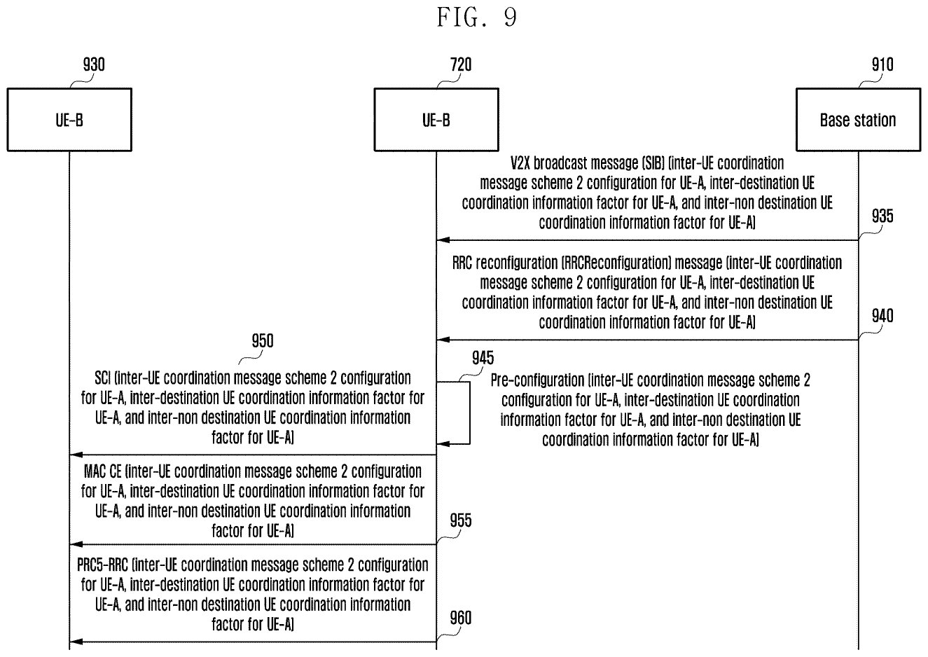

FIG. 9 illustrates a method of providing UE-A with configurations for inter-UE coordination scheme 2 according to various embodiments of the disclosure.

Referring to FIG. 9, for configuration of the inter-UE coordination scheme 2 for a UE-A 930, a base station 910 may provide the UE-B 720 with at least one of the following information through a V2X broadcast message (SIB) (step 935) or an RRC reconfiguration (RRCReconfiguration) message (step 940). In addition, at least one of the following information may be pre-configured in the V2X layer of the UE-B 720 in step 945.
inter-UE coordination scheme 2 configuration for the UE-A 930, QoS flow and sidelink data radio bearer (SL-DRB) mapping information, sidelink data radio bearer (SL-DRB) information, sidelink logical channel information, inter-destination UE coordination information for the UE-A, and inter-non-destination UE coordination information for the UE-A 930.
When providing the inter-UE coordination scheme 2 configuration for the UE-A 930 to the UE-B 720, the UE-B 720 may transmit the inter-UE coordination scheme 2 configuration to the UE-A 930 through at least one of the SCI (step 950), the MAC CE (step 955), or the PC5-RRC (step 960) message.

When receiving the SCI including the corresponding configuration (step 950), the UE-A 930 may be configured in two ways as follows.
1) When a conflict occurs between the reserved resource indicated by the SCI including the corresponding configuration and other reserved resources of the UE-A 930, the UE-A 930 may transmit an inter-UE coordination message to the UE-B 720.
2) The UE-A 930 may store configuration information on the source identifier (Source Layer-2 ID), destination identifier (Destination Layer-2 ID), and cast type of the SCI and SL-SCH subheader transmitted by the UE-B 720 for the SCI including the corresponding configurations and subsequent SCIs, and when a conflict occurs between the reserved resource indicated by the SCI and other reserved resources of the UE-A 930, the UE-A 930 may transmit an inter-UE coordination message to the UE-B 720.

When receiving the MAC CE including the corresponding configuration (step 955), the UE-A 930 may be configured in two ways as follows.
1) When a conflict occurs between the reserved resource indicated by the SCI reserving resources for transmitting MAC PDUs including MAC CE with the corresponding configuration and other reserved resources of the UE-A 930, the UE-A 930 may transmit an inter-UE coordination message to the UE-B 720.
2) The UE-A 930 may store configuration information on the source identifier (Source Layer-2 ID), destination identifier (Destination Layer-2 ID), and cast type of the SCI and SL-SCH subheader reserving resources for transmitting MAC PDUs including MAC CE with the corresponding configuration, and when a conflict occurs between the reserved resource indicated by the SCI and other reserved resources of the UE-A 930, the UE-A 930 may transmit an inter-UE coordination message to the UE-B 720.

When a unicast link between the UE-A 930 and the UE-B 720 is configured, the UE-B 720 may transmit the inter-UE coordination scheme 2 configuration to the UE-A 930 through a PC-5 RRC message (step 960). When the inter-UE coordination scheme 2 configuration is transmitted through the PC-5 RRC message, the UE-A 930 may store configuration information on the source identifier (Source Layer-2 ID), destination identifier (Destination Layer-2 ID), and cast type of the UE-B 720, and when a conflict occurs between the reserved resource indicated by the SCI transmitted by the UE-B 720 thereafter and other resources already reserved in the UE-A 930, the UE-A 930 may transmit an inter-UE coordination message to the UE-B 720.
According to an embodiment, the UE-B 720 may transmit to the UE-A 930 an inter-destination UE coordination information factor for the UE-A 930 and an inter-non-destination UE coordination information factor for the UE-A 930 through the SCI 950. The UE-A 930 may store the transmitted information along with the priority indicated by the transmitted SCI.
According to an embodiment, the UE-B 720 may transmit to the UE-A 930 an inter-destination UE coordination information factor for the UE-A 930 and an inter-non-destination UE coordination information factor for the UE-A 930 through the MAC CE 955. The UE-A 930 may store the transmitted information along with the priority indicated by the transmitted SCI.
According to an embodiment, when a unicast link between the UE-B 720 and the UE-A 930 is configured, the UE-B 720 may provide QoS flow, sidelink data radio bearer (SL-DRB) mapping information or sidelink data radio bearer (SL-DRB) information or sidelink logical channel information, an inter-destination UE coordination information factor for the UE-A 930, and an inter-non-destination UE coordination information factor for the UE-A 930 to the UE-A 930 through the PC5 RRC message 960. The UE-A 930 may store provide QoS flow transmitted by the UE-B 720, sidelink data radio bearer (SL-DRB) mapping information or sidelink data radio bearer (SL-DRB) information or sidelink logical channel identifier (SL-LogicalChannelIdentity)related to sidelink logical channel information, an inter-destination UE coordination information factor for the UE-A 930, and an inter-non-destination UE coordination information factor for the UE-A 930.
The inter-destination UE coordination information factor for the UE-A 930 is the probability that the UE-A 930 may transmit an inter-UE coordination message when the UE-A 930 is determined to be the destination terminal in step 640. This information may be expressed, for example, as follows.

IUC-UEADestinationFactorScheme2-r17xy ENUMERATED {p00, p05, p10, p15, p20, p25, p30, p40, p50, p60, p70, p75, p80, p85, p90, p95},
The inter-non-destination UE coordination information factor for the UE-A 930 is the probability that the UE-A 930 may transmit an inter-UE coordination message when the UE-A 930 is determined to be the non-destination terminal in step 640. This information may be expressed, for example, as follows.

IUC-UEANonDestinationFactorScheme2-r17xyENUMERATED {p00, p05, p10, p15, p20, p25, p30, p40, p50, p60, p70, p75, p80, p85, p90, p95},

In the above factors, p00 may be a probability of 0, and p 95 may be a probability of 0.95. If the information is not transmitted, the UE-A 930 may apply a probability of 1. Of course, the value may not be configured only in a probability unit of 0.05, but may be provided flexibly in a narrower or wider range.

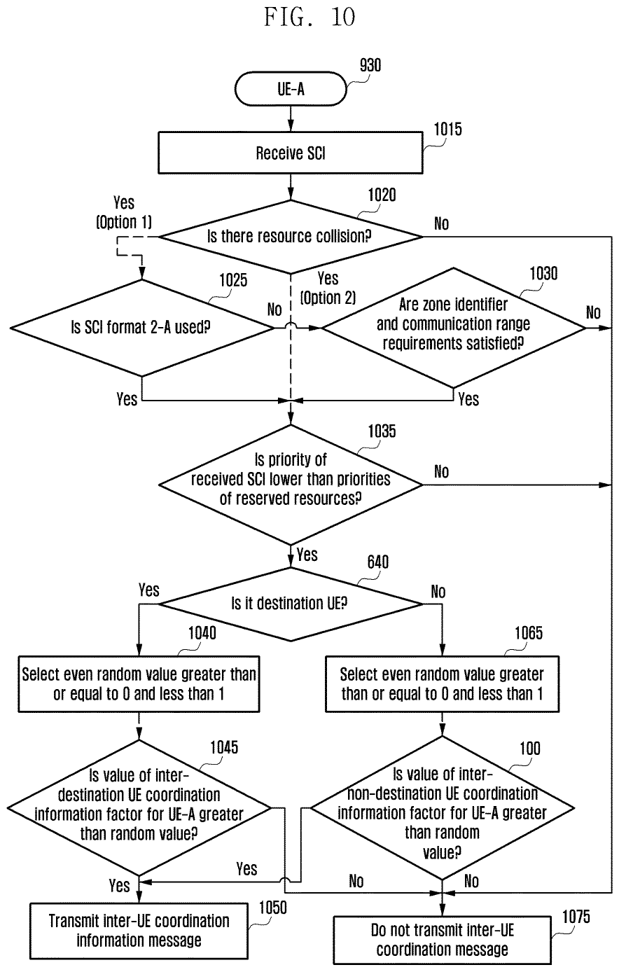

FIG. 10 illustrates the operation of UE-A's inter-UE coordination scheme 2 according to various embodiments of the disclosure.

Referring to FIG. 10, the UE-A 930 may be configured from the UE-B 720 to perform an operation of the inter-UE coordination scheme 2 according to FIG. 9. In addition, the terminal may operate as follows.
In step 1015, the UE-A 930 may receive the SCI transmitted from the UE-B 720 and identify whether there is a resource conflict in step 1020. The type of resource conflict may include at least one of the following two.
1) Indicates a case in which the UE-A 930 cannot receive a transmission using the resource reserved by UE-B 720 due to a half-duplex constraints because of a conflict between the resource reserved by UE-A 930 for sidelink transmission and the resource reserved by UE-B 720 for sidelink transmission.
2) Indicates a case in which a resource reserved by the UE-B 720 may act as an interference source or be interfered with by the UE-A 930 due to a conflict with a resource reserved by a UE other than the UE-A 930.

If a resource conflict is not identified in step 1020, the UE-A 930 may proceed to step 1075 and may not transmit the inter-UE coordination information message.

(Option 1) If a resource conflict is identified in step 1020, the UE-A 930 may proceed to step 1025.
If the second stage SCI of the UE-B 720 is SCI format 2-A in step 1025, the UE-A 930 may proceed to step 1035. If the second stage SCI of the UE-B 720 is SCI format 2-B, the UE-A 930 may proceed to step 1030.
In step 1030, the UE-A 930 may identify whether the zone identifier and communication range requirements are satisfied. When the zone identifier and communication range requirements are satisfied, the UE-A 930 may proceed to step 1035. When the zone identifier and communication range requirements are not satisfied, the UE-A 930 may proceed to step 1075 and may not transmit the inter-UE coordination information message. Identifying satisfaction of requirements follows Release 16 of 3GPP TS 38.321 and 38.331, and a detailed description is omitted in the disclosure.

(Option 2) If a resource conflict is identified in step 1020, the UE-A 930 may skip steps 1025 and 1030 and proceed to step 1035.
In step 1035, the UE-A 930 may compare the priority indicated by the SCI 1015 transmitted from the UE-B 720 with the priority included in the SCI indicating existing reserved resources. If the priority indicated by the SCI 1015 transmitted from the UE-B 720 is lower than at least one of the priorities of resources identified by conflict, the UE-A 930 may proceed to step 640 to execute the following steps for transmitting an inter-UE coordination information message. If the priority indicated by the SCI 1015 in step 1035 is higher than all priorities of conflicted resources, the UE-A 930 may proceed to step 1075, and may not transmit the inter-UE coordination information message. The priority described above refers to an absolute priority, may not refer to low and high configured value, and according to the general 3GPP priority definition, a low value may refer to high priority, and a high value may refer to low priority.
When the UE-A 930 received an inter-destination UE coordination information factor for the UE-A 930 or an inter-non-destination UE coordination information factor for the UE-A 930 through a SCI or MAC CE message, and the UE-A 930 is determined to be the destination terminal according to the result of step 640, the UE-A 930 may select an even random value greater than or equal to 0 and less than 1 in step 1040. In addition, in step 1045, the UE-A 930 may determine whether the value of the inter-destination UE coordination information factor for the UE-A 930 is greater than the selected random value. If the value of the inter-destination UE coordination information factor for the UE-A 930 is greater than the selected random value, the UE-A 930 may proceed to step 1050 to transmit an inter-UE coordination information message. When the UE-A 930 is determined to be the non-destination terminal according to the result of step 640, the UE-A 930 may select an even random value greater than or equal to 0 and less than 1 in step 1065. In addition, in step 1070, the UE-A 930 may determine whether the value of the inter-non-destination UE coordination information factor for the UE-A 930 is greater than the selected random value. If the value of the inter-non-destination UE coordination information factor for the UE-A 930 is greater than the selected random value, the UE-A 930 may proceed to step 1050 to transmit an inter-UE coordination information message. In step 1045 or 1070, if the value of the inter-destination UE coordination information factor or the value of the inter-non-destination UE coordination information factor for the UE-A 930 is less than the selected random value, the UE-A 930 may proceed to step 1075 and may not transmit the inter-UE coordination information message.
When the UE-A 930 received an inter-destination UE coordination information factor for the UE-A 930 or an inter-non-destination UE coordination information factor for the UE-A 930 through a PC5-RRC message, and the UE-A 930 is determined to be the destination terminal according to the result of step 640, the UE-A 930 may select an even random value greater than or equal to 0 and less than 1 in step 1040. In addition, in step 1045, the UE-A 930 may determine whether the value of the inter-destination UE coordination information factor for the UE-A 930 related to the sidelink logical channel identifier of the SL MAC subPDUs included in the MAC PDU and the corresponding sidelink logical channel identifier is greater than the selected random value. If the value of the inter-destination UE coordination information factor for the UE-A 930 related to the sidelink logical channel identifier of the SL MAC subPDUs included in the MAC PDU and the corresponding sidelink logical channel identifier is greater than the selected random value, the UE-A 930 may proceed to step 1050 to transmit an inter-UE coordination information message. When the UE-A 930 is determined to be the non-destination terminal according to the result of step 640, the UE-A 930 may select an even random value greater than or equal to 0 and less than 1 in step 1065. In addition, in step 1070, the UE-A 930 may determine whether the value of the inter-non-destination UE coordination information factor for the UE-A 930 related to the sidelink logical channel identifier of the SL MAC subPDUs included in the MAC PDU and the corresponding sidelink logical channel identifier is greater than the selected random value. If the value of the inter-non-destination UE coordination information factor for the UE-A 930 related to the sidelink logical channel identifier of the SL MAC subPDUs included in the MAC PDU and the corresponding sidelink logical channel identifier is greater than the selected random value, the UE-A 930 may proceed to step 1050 to transmit an inter-UE coordination information message. In step 1045 or 1070, if the value of the inter-destination UE coordination information factor or the value of the inter-non-destination UE coordination information factor for the UE-A 930 is less than the selected random value, the UE-A 930 may proceed to step 1075 and may not transmit the inter-UE coordination information message.

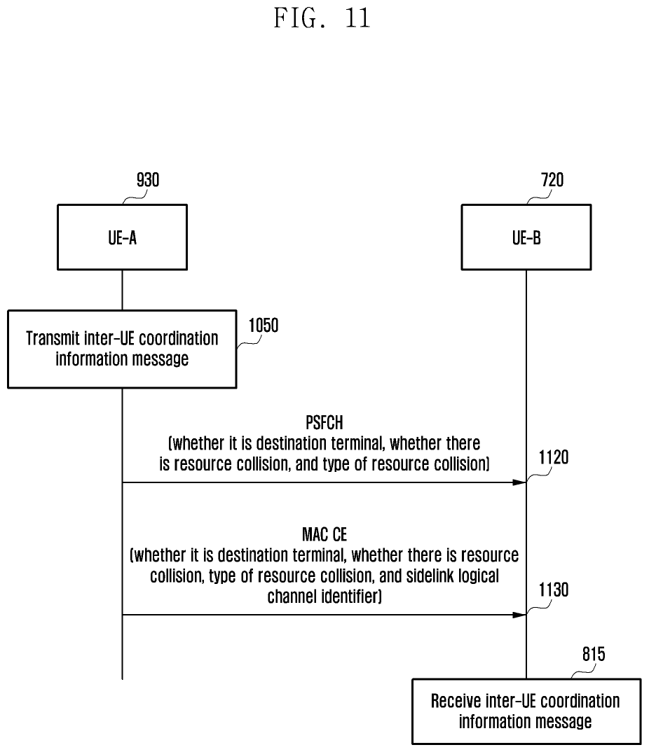

FIG. 11 illustrates a method for transmitting an inter-UE coordination message of UE-A's inter-UE coordination scheme 2 according to various embodiments of the disclosure.

Referring to FIG. 11, when it is determined to transmit the inter-UE coordination message in step 1050 according to FIG. 10, the UE-A 930 may transmit a message indicating a conflict of resources to the UE-B 720 through a physical sidelink feedback channel (PSFCH) (step 1120) and/or transmit a message indicating a conflict of resources to the UE-B 720 through a MAC CE (step 1130).

When transmitting through the PSFCH (step 1120), the transmission may be performed including at least one of the following information.
Whether it is a destination terminal, whether there is a resource conflict, and the type of resource conflict
Whether it is a destination terminal indicates whether the UE-A 930 is a destination terminal or non-destination terminal that may be determined in step 640.
Whether there is a resource conflict indicates whether there is a resource conflict that the UE-A 930 may determine in step 1020.
The type of resource conflict may include at least one of the following information.
1) Indicates a case in which the UE-A 930 cannot receive a transmission using the resource reserved by UE-B 720 due to a half-duplex constraints because of a conflict between the resource reserved by the UE-A 930 for sidelink transmission and the resource reserved by the UE-B 720 for sidelink transmission.
2) Indicates a case in which a resource reserved by the UE-B 720 may act as an interference source or be interfered with by the UE-A 930 due to a conflict with a resource reserved by a UE.

When transmitting through the MAC CE (step 1130), the transmission may be performed including at least one of the following information.
Whether it is a destination terminal, whether there is a resource conflict, the type of resource conflict, and a sidelink logical channel identifier
Whether it is a destination terminal indicates whether the UE-A 930 is a destination terminal or non-destination terminal that may be determined in step 640.
Whether there is a resource conflict indicates whether there is a resource conflict that the UE-A 930 may determine in step 1020.
The type of resource conflict may include at least one of the following information.
1) Indicates a case in which the UE-A 930 cannot receive a transmission using the resource reserved by UE-B 720 due to a half-duplex constraints because of a conflict between the resource reserved by UE-A 930 for sidelink transmission and the resource reserved by UE-B 720 for sidelink transmission.
2) Indicates a case in which a resource reserved by the UE-B 720 may act as an interference source or be interfered with by the UE-A 930 due to a conflict with a resource reserved by a UE.
The sidelink logical channel identifier represents the sidelink logical channel identifier indicated by the SL MAC subPDUs included in the MAC PDU. If there are two or more logical channels where resource conflict occur, multiple sidelink logical channel identifiers may be transmitted.

When the UE-B 720 receives an inter-UE coordination information message, the UE-B 720 may proceed to step 815 to reselect transmission resources according to FIG. 8.

The methods according to various embodiments described in the claims or the specification of the disclosure may be implemented by hardware, software, or a combination of hardware and software.

When the methods are implemented by software, a computer-readable storage medium for storing one or more programs(software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Furthermore, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Furthermore, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method performed by a first terminal in a wireless communication system, the method comprising:
receiving, from a base station, a first message comprising configuration information of an inter-UE (user equipment) coordination scheme 2;
transmitting, to a second terminal, sidelink control information (SCI) comprising resource allocation information for sidelink communication between the first terminal and the second terminal;
receiving, from the second terminal, a second message including conflict information indicating that the resource for the sidelink communication and another transmission resource configured to the second terminal conflict based on the SCI; and
reselecting resources for sidelink communication with the second terminal, based on the conflict information.

2. The method of claim 1, wherein the SCI further comprises information on whether the first terminal is able to receive the conflict information from the second terminal.

3. The method of claim 1, wherein the second message is transmitted in a physical sidelink feedback channel (PSFCH).

4. The method of claim 1, wherein the conflict information is maintained for a time determined based on a remaining packet delay budget.

5. A method performed by a second terminal in a wireless communication system, the method comprising:
receiving, from a first terminal, sidelink control information (SCI) comprising resource allocation information for sidelink communication between the first terminal and the second terminal, according to configuration of an inter-UE (user equipment) coordination scheme 2;
determining whether the resource for the sidelink communication and another transmission resource configured to the second terminal conflict based on the SCI; and
transmitting, to the first terminal, a message including conflict information indicating that the resource for the sidelink communication and another transmission resource configured to the second terminal conflict, in case that the resource for the sidelink communication and another transmission resource configured to the second terminal conflict.

6. The method of claim 5, wherein the SCI further comprises information on whether the first terminal is able to receive the conflict information from the second terminal.

7. The method of claim 5, wherein the message is transmitted in a physical sidelink feedback channel (PSFCH).

8. The method of claim 5, wherein the conflict information is maintained for a time determined based on a remaining packet delay budget.

9. A first terminal in a wireless communication system, the first terminal comprising:
a transceiver; and
a controller coupled with the transceiver and configured to:
receive, from a base station, a first message comprising configuration information of an inter-UE (user equipment) coordination scheme 2,
transmit, to a second terminal, sidelink control information (SCI) comprising resource allocation information for sidelink communication between the first terminal and the second terminal,
receive, from the second terminal, a second message comprising conflict information indicating that the resource for the sidelink communication and another transmission resource configured to the second terminal conflict based on the SCI, and
reselect resources for sidelink communication with the second terminal, based on the conflict information.

10. The first terminal of claim 9, wherein the SCI further comprises information on whether the first terminal is able to receive the conflict information from the second terminal.

11. The first terminal of claim 9, wherein the second message is transmitted in a physical sidelink feedback channel (PSFCH).

12. The first terminal of claim 9, wherein the conflict information is maintained for a time determined based on a remaining packet delay budget.

13. A second terminal in a wireless communication system, the second terminal comprising:
a transceiver; and
a controller coupled with the transceiver and configured to:
receive, from a first terminal, sidelink control information (SCI) comprising resource allocation information for sidelink communication between the first terminal and the second terminal, according to configuration of an inter-UE (user equipment) coordination scheme 2,
determine whether the resource for the sidelink communication and another transmission resource configured to the second terminal conflict based on the SCI, and
transmit, to the first terminal, a message including conflict information indicating that the resource for the sidelink communication and another transmission resource configured to the second terminal conflict, in case that the resource for the sidelink communication and another transmission resource configured to the second terminal conflict.

14. The second terminal of claim 13, wherein the SCI further comprises information on whether the first terminal is able to receive the conflict information from the second terminal.

15. The second terminal of claim 14,
wherein the message is transmitted in a physical sidelink feedback channel (PSFCH), and
wherein the conflict information is maintained for a time determined based on a remaining packet delay budget.
